(19) United States
(12) Patent Application Publication
(10) Pub. No.: US 2009/0039309 A1
(43) Pub. Date: Feb. 12, 2009

(54) MAGNETORHEOLOGICAL ELASTOMER COMPOSITES AND USE THEREOF

(75) Inventors: Holger BOSE, Wurzburg (DE); Rene Roder, Grossenlupnitz (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Fraunhofer-Gesellschaft zur Forderung der angewandten Forschung e.V., Munchen (DE)

(21) Appl. No.: 11/995,300

(22) PCT Filed: Jul. 13, 2006
(86) PCT No.: PCT/EP2006/006864

§ 371 Date: May 27, 2008

(30) Foreign Application Priority Data
Jul. 26, 2005 (DE) 10 2005 034 925.0

(51) Int. Cl. H01F 1/04; H05B 6/00

(52) U.S. Cl. 252/62.55; 252/62.6; 264/427

(57) ABSTRACT

Magnetorheological elastomer composites comprising at least one thermoplastic elastomer which forms a thermoplastic matrix and magnetisable particles which are contained therein, the elastomer matrix containing at least 10% by weight of plasticiser, relative to the thermoplastic elastomer.

The invention relates to magnetorheological elastomer composites comprising at least one thermoplastic elastomer which forms a thermoplastic matrix and magnetisable particles which are contained therein, at least 10% by weight of plasticiser being contained in the elastomer matrix, relative to the thermoplastic elastomers.

Magnetically controllable elastomer composites, so-called magnetorheological elastomers (MRE), are known already in a general form. Much more widespread are magnetorheological liquids (MRF), in which the magnetisable particles are distributed in a carrier liquid. Because of the lack of cross-linking of the molecules in the carrier liquid, such materials have however no solid form but are liquid and hence irreversibly deformable.

The possibility is likewise known of producing a chain-like arrangement of particles in an MRE during cross-linking by applying a magnetic field. Silicones have been used to date for this purpose, which were used as pourable precursors. In addition, the use of other commercially widespread elastomers comprising natural and synthetic rubber, such as e.g. nitrile rubber, has been described. By means of this, only relatively small changes in mechanical properties in the magnetic field have however been achieved. Also the use of different magnetic particle materials in MRE has already been mentioned in a general form.

MREs are known from US 2005/0116194 A1 which comprise a thermoplastic matrix and magnetisable particles. The elongations at breack of the MREs described therein leave a lot to be desired however. In the above-described US patent, a elongation at breack is in fact mentioned which can be greater than 200%, in fact even greater than 1000%, but this elongation at breack relates not to the MRE as such, i.e. to the elastomer matrix with he magnetisable particles contained therein, but to the elastomer itself.

Starting herefrom, it is therefore the object of the present invention to make available magnetorheological elastomer composites (MREs) which have a significantly increased elongation at breack in particular relative to the MREs known from prior art. In addition, the MREs should make possible a high increase factor in mechanical properties, such as e.g. the modulus of rigidity in the magnetic field.

This object is achieved with respect to the composite by the characterising features of patent claim 1. The method for producing the composites is described in claim 22 and the use of the elastomers according to the invention is described in claim 24. The dependent sub-claims reveal advantageous developments.

It is hence proposed according to the invention that the magnetorheological elastomer composites of the invention contain, in addition to the elastomer matrix, which is formed from the thermoplastic elastomer, and the magnetisable particles, at least 10% by weight of a plasticiser, relative to the thermoplastic elastomers. In the case of the MREs according to the invention, in contrast hence to the state of the art in which softeners are contained merely in small quantities as an additive, the plasticiser is added as a structure-forming component in fairly large quantities, i.e. with at least 10% by weight, relative to the thermoplastic elastomers. By incorporating such large quantities of plasticisers, a very low basic hardness of the elastomer is set, which then makes possible particularly high increase rates in mechanical properties, such as e.g. of the elongation at breack, up to more than 1000% or in the modulus of rigidity in the magnetic field. The MREs according to the invention have the further advantage that easy processibility is provided. In comparison with the elastomer materials which are used in the MREs of prior art, now the elastomer composites according to the invention can be processed even better with current methods known in the field of thermoplasts such as extrusion or injection moulding. Hence also complex moulded parts can be produced economically on a large scale. Since the cross-linking in a thermoplastic elastomer is produced by physical interaction, the components produced therefrom can be recycled readily by melting at high temperatures. Even the magnetisable particles which are contained in the MREs according to the invention can be removed from the melt, for example by applying a magnetic field or by filtration. A further advantage of the MREs according to the invention is that these have a high resistance relative to polar media, such as acids, bases and also water, and also relative to UV radiation. The possible ranges of temperatures of use extend approx. from −40 to +120° C.

It was established in addition that both the storage modulus (describes the elastic behaviour or energy storage) and the loss modulus (describes the viscous behaviour or energy dissipation) are influenced by the magnetic field. The same is true also for the loss factor as ratio of loss and storage modulus. Hence commercially significant possibilities are produced for controlled oscillation damping or oscillation isolation.

A further interesting property of the magnetorheological elastomer composites of the invention resides in the occurrence of a shape memory effect. In the magnetic field and hence in the rigidified state of the composite, an object formed from the composite material can be deformed by the effect of external forces. The new shape is subsequently maintained as long as the magnetic field is acting. After switching off the magnetic field, the object reverts to its original shape. This effect can be attributed to the fact that in the magnetic field the magnetic forces between the particles dominate, whilst the behaviour without a magnetic field is determined by the elastic forces of the elastomer. A prerequisite for this resides in the fact that the elastic forces are not too great. A soft elastomer matrix is therefore particularly advantageous. The described behaviour can be used for safety systems.

A further possibility for using magnetically soft controllable elastomere composites resides in the construction of a magnetic circuit with the inclusion of an electromagnet and a permanent magnet. By selection of the permanent magnet, increased basic rigidity of the elastomer composite can be set. The electromagnet can strengthen or weaken the magnetic field according to the direction of the generated current and hence can either increase or reduce the rigidity of the elastomer composite (modulus of elasticity or modulus of rigidity). Hence for example the operating point can be fixed in an oscillation-damping system.

In the case of the magnetorheological elastomer composites of the invention, it has emerged as favourable if paraffinic or naphthenic oils are used as plasticisers. The plasticiser is thereby preferably used with 20 to 300% by weight, particularly preferred with 30 to 200% by weight, relative to the thermoplastic elastomers. Further preferred ranges are 40 to 200, 50 to 200, 60 to 200 and also 80 to 200% by weight.

In the case of the thermoplastic elastomers, those are preferred which have a Shore hardness of less than 20, particularly preferred less than 10. Further favourable properties which the thermoplastic elastomer should have are a modulus of rigidity at a frequency of 10 Hz and a deformation of 1% of less than 500 kPa, preferably less than 250 kPa, particularly preferred <150 kPa. Good results are achieved also in addition if the modulus of rigidity is <100 kPa. It is preferred in addition if a modulus of elasticity is present which is less than 1500 kPa, particularly preferred less than 750 kPa.

The modulus of rigidity according to the invention describes the mechanical behaviour of the material during shear deformation in that it produces the correlation between the shearing stress which produces the shear deformation and the deformation angle.

With more precise consideration, a phase shift between shearing stress and deformation occurs during a sinusoidal shear deformation. This is described by a complex modulus of rigidity G*=G′+i G″, the real part G′ being termed storage modulus (describes the elastic behaviour of the material or energy storage) and the imaginary part G″ the loss modulus (describes the viscous behaviour of the material or energy dissipation). If the imaginary part relative to the real part is negligible, the modulus of rigidity can be equated to the storage modulus. Otherwise, the modulus of rigidity is produced as the value of the complex variable (G=(G′²+G″²)^{1/2}). The storage modulus cannot hence be greater than the modulus of rigidity but at most equal to the latter.

From the point of view of materials, there are preferred as thermoplastic elastomer in particular styrene block copolymers. There are preferred hereby styrene-olefin block copolymers. Examples of these are styrene-ethylene-butylene block copolymers and also styrene-ethylene-propylene block copolymers. The thermoplastic elastomers which the elastomer matrix of the MREs according to the invention forms can of course also be used in a mixture.

In the case of the magnetisable particles, all the magnetisable particles known in prior art for MREs can be used per se.

In this respect, there are suitable magnetisable particles comprising magnetically soft materials, such as e.g. magnetisable particles comprising magnetically soft metallic materials or also comprising magnetically soft oxide-ceramic materials. Example of magnetically soft metallic materials are iron, cobalt, nickel and alloys thereof, such as iron cobalt, iron nickel, magnetic steel and iron silicon. In the case of the oxide-ceramic materials, in particular the cubic ferrites, perovskites and garnets of the general formula MO.Fe₂O₃ with one or more metals from the group M=Mn, Fe, Co, Ni, Cu, Zn, Ti, Cd or magnesium and/or mixtures thereof are preferred. In the present invention, there can be used, in the case of the magnetisable particles, also particles comprising mixed ferrites, such as MnZn, NiZn, NiCo, NiCuCo, NiMg and also CuMg ferrites and/or mixtures thereof. The use of iron carbide-iron nitride alloys of vanadium, tungsten, copper and manganese is also favourable.

As is known per se in prior art, the magnetisable particles can also be distributed uniformly in the elastomer matrix in the case of the MREs according to the invention (isotropic material) or a chain-shaped structure along the field lines can be impressed upon the magnetisable particles (anisotropic material) by applying a magnetic field, before and/or during cooling of the melt. As a result of the strength of the magnetic field prevailing during the cross-linking, the impressed structure can thereby be prescribed.

In the MREs of the invention, in addition to the essential formulation components which are defined in claim 1, also additives, such as dispersion agents, antioxidants, defoamers, surface modifiers, fillers, colourants and/or antiwear agents can be contained in addition.

In the case of the elastomer composites according to the invention, it is thereby preferred if, relative to 100% by volume, the elastomer matrix contains 1 to 70% by volume, particularly preferred between 10 and 50% by volume, of magnetisable particles. The elastomer composites according to the invention can of course contain, as known per se from prior art, also 0.1 to 20% by weight of additives. The weight quantity of the additive is thereby relative to the thermoplastic elastomer.

The invention relates furthermore to a method for producing the elastomer composites as described above.

The method according to the invention is thereby implemented such that the thermoplastic elastomer is mixed with the softener in a corresponding quantity and in that the magnetisable particles are then added to this mixture. It has thereby emerged as favourable if the educts are agitated and homogenised. The thus produced mixture can be melted and agitated in addition then in an oven at increased temperature as a function of the selected thermoplastic elastomer. The then resulting suspension can be cast for example in a mould and then be cured during cooling to form the composite.

The present invention relates furthermore to the use of the previously described MREs.

A preferred use of the MREs according to the invention resides in damping systems in which the value of the damping or oscillation isolation can be changed temporarily by a variable magnetic field. In addition, with magnetically controllable elastomer composites with thermoplastic elastomers, haptic systems can be produced in which the rigidity of a surface is perceptibly changed. As a result of the high deformability of the elastomer composites, artificial muscles are in addition conceivable, the elongation or contraction of which is controlled magnetically.

Further possibilities for application reside in actuators or safety switches in which a movement is initiated by using the shape memory effect by changing the magnetic field. The invention is described subsequently in more detail with reference to embodiments and Figures.

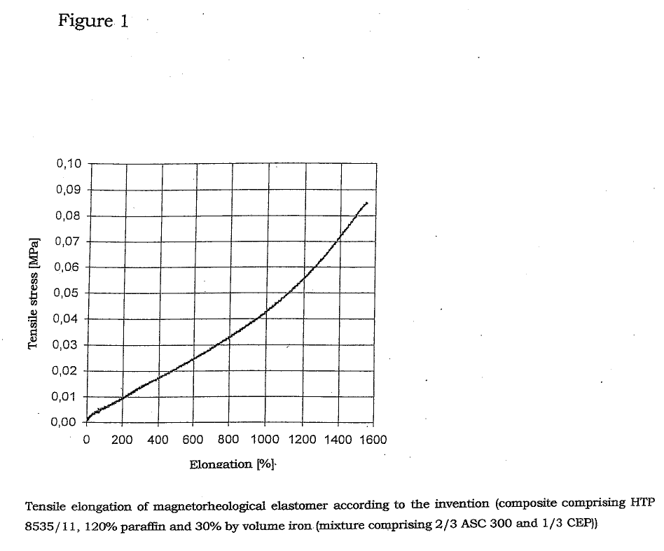

FIG. 1 thereby shows the force-elongation curve of an MRE according to the invention,

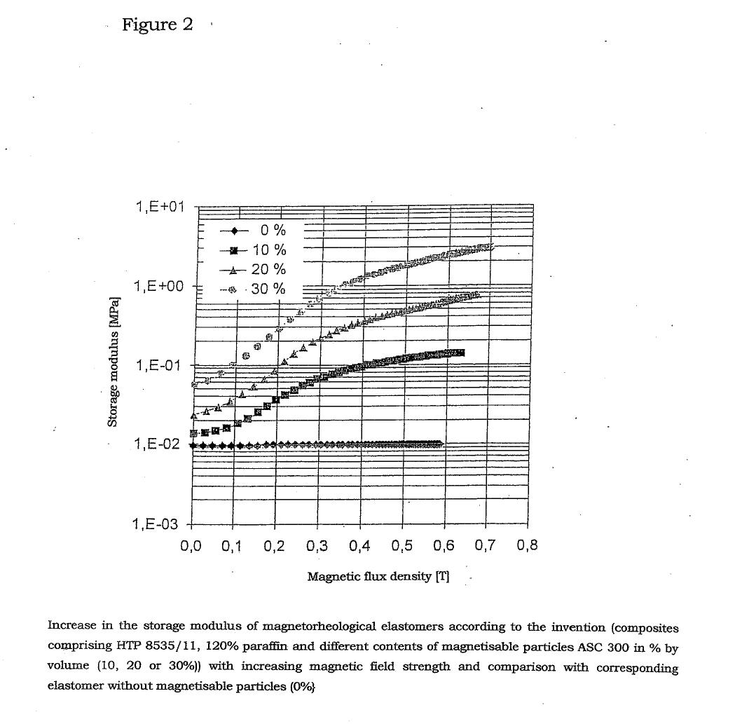

FIG. 2 the increase in the storage modulus of the MREs according to the invention with the magnetic flux density in the case of different volume contents of magnetisable particles,

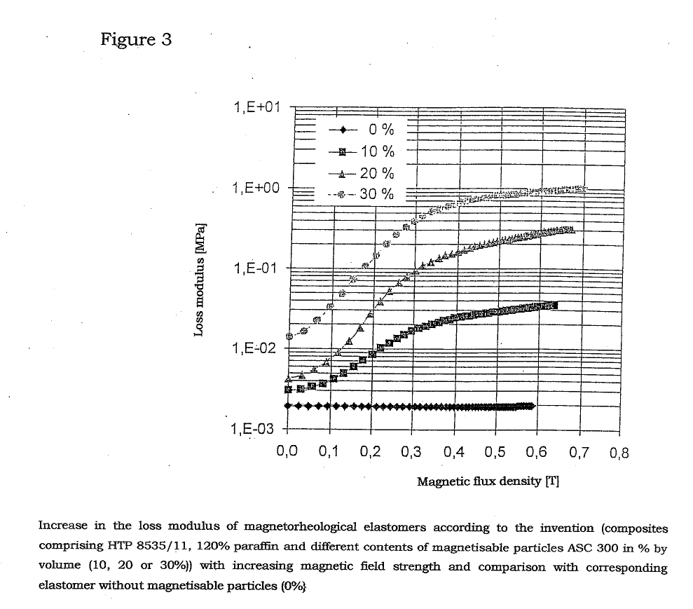

FIG. 3 the increase in the loss modulus of the MREs according to the invention with the magnetic flux density in the case of different volume contents of magnetisable particles.

### Embodiments

### Embodiment 1

Magnetorheological elastomer comprising thermoplastic elastomer, 120% of plasticiser relative to the thermoplastic elastomer, and 10% by volume of iron particles

3.64 g granulate (styrene block copolymer, density 0.89 g/cm³, HTP 8534/11, Thermolast K, Kraiburg TPE GmbH) are mixed with 4.36 g paraffin, low viscosity, Ph Eur, BP, NF (density 0.85 g/cm³, Merck) and steeped for 24 hours at temperature in a temperature-resistant beaker glass. Subsequently, 8.02 g iron powder (density 7.84 g/cm³, Höganäs ASC 300, average particle size 41 μm) are added, agitated with a glass rod and homogenised. The mixture is melted in an oven at 190° C. and agitated until it is homogeneous. Thereupon, the suspension is cast in a steel mould which is likewise preheated to 190° C. After cooling to room temperature, the sample is removed from the mould as a plate with a thickness of 1 mm.

### Embodiment 2

Magnetorheological elastomer comprising thermoplastic elastomer, 120% of plasticiser and 20% by volume of iron particles

The production is effected analogously to embodiment 1, the quantity of the iron powder being increased to 18.06 g.

### Embodiment 3

Magnetorheological elastomer, comprising thermoplastic elastomer, 120% of plasticiser and 30% by volume of iron particles

The production is effected analogously to embodiment 1, the quantity of the iron powder being increased to 30.95 g.

### Comparative example 1

Thermoplastic elastomer with 120% of softener without iron particles

The production is effected analogously to embodiment 1, no iron powder being added.

### Implementation of the Measurements on the Magnetorheological Elastomers

The elongation at breack of the magnetorheological elastomer samples was measured in a Zwick mechanical testing machine. A sample of 40 mm length, 5 mm width and 1 mm thickness was thereby used. During the measurement, the sample was elongated until breaking at a tensile rate of 120 mm/min.

The viscoelastic properties of the magnetorheological elastomer samples were examined in a rotational rheometer MCR300 by the company Paar-Physica in a magnetic field of variable strength. The disc-shaped sample with 20 mm diameter is thereby situated between two parallel, horizontally disposed plates, the upper plate of which exerts a prescribed rotary oscillation and hence the sample is subjected to shear deformation in an oscillating manner. The magnetic field penetrates the sample vertically, i.e. perpendicular to the plate plane. The amplitude of the shear deformation was kept constant at 0.01 (corresponds to 1%). The frequency of the oscillation was 10 Hz, the temperature was 25° C. During the measurement, the current strength in the magnet field-exciting coil was increased gradually and hence the magnetic field was increased.

During the measurement, apart from the shear deformation, also the shear stress and the phase shift between two values are recorded by the measuring apparatus. From the measuring values, the storage modulus G′ (real part of the complex modulus of rigidity) and the loss modulus G″ (imaginary part of the complex modulus of rigidity) are determined. The storage modulus describes the elastic behaviour of the material (storage of mechanical energy) whilst the loss modulus describes the viscous behaviour of the material (dissipation of mechanical energy and conversion into heat).

### Notes Relating to the Measuring Results

The force-elongation curve in FIG. 1 shows that the magnetorheological elastomer can be elongated by up to approx. 1500% before it breaks.

The measuring results obtained with the rheometer show that the viscoelastic properties of the magnetorheological elastomers can be changed by the magnetic field strength to a very great degree. The viscoelastic properties depend in addition upon the volume proportion of the iron particles in the elastomer. In embodiment 3, the storage modulus is increased by a magnetic field which is increased during the measurement with a flux density of up to 700 mT from an initial value of 60 kPa to a value of almost 3 MPa, i.e. by a factor of approx. 50 (see FIG. 2). For the loss modulus, an increase of 15 kPa to approx. 1 MPa is achieved with this sample (see FIG. 3).

1. A magnetorheological elastomer composite comprising at least one thermoplastic elastomer which forms a thermoplastic elastomer matrix and magnetisable particles which are contained therein, wherein the elastomer matrix contains at least 10% by weight of plasticiser, relative to the thermoplastic elastomer.

2. The magnetorheological elastomer composite according to claim 1, which contains 20 to 300% by weight of plasticiser.

3. The magnetorheological elastomer composite according to claim 2, which contains 30 to 200% by weight of plasticiser.

4. The magnetorheological elastomer composite according to claim 1, wherein the plasticiser is selected from paraffinic oils and naphthenic oils.

5. The magnetorheological elastomer composite according to claim 1, wherein the elastomer matrix has a modulus of rigidity (at 10 Hz and deformation 1%) of <500 kPa.

6. The magnetorheological elastomer composite according to claim 5, wherein the modulus of rigidity is <250 kPa.

7. The magnetorheological elastomer composite according to claim 1, wherein the thermoplastic elastomer of the elasatomer matrix is a styrene block copolymer. cm 8. The magnetorheological elastomer composite according to claim 7, wherein the styrene block copolymer is a styrene-olefin block copolymer.

9. The magnetorheological elastomer composite according to claim 1, wherein the magnetisable particles are selected from magnetic materials.

10. The magnetorheological elastomer composite according to claim 1, wherein the magnetisable particles are selected from magnetically soft metallic materials.

11. The magnetorheological elastomer composite according to claim 1, wherein the magnetisable particles are selected from magnetically soft oxide ceramic materials.

12. The magnetorheological elastomer composite according to claim 1, wherein the magnetisable particles are selected from mixed ferrites.

13. The magnetorheological elastomer composite according to claim 1, wherein the magnetisable particles are selected from the group consisting of iron carbide, iron nitride, alloys of vanadium, tungsten, copper and manganese and mixtures thereof.

14. The magnetorheological elastomer composite according to claim 1, wherein the average particle size of the magnetisable particles is between 5 nm 10 nm.

15. The magnetorheological elastomer composite according to claim 1, wherein the magnetisable particles have a bimodal or trimodal size distribution.

16. The magnetorheological elastomer composite according to claim 1, wherein the magnetisable particles have an anisotropic distribution in the elastomer matrix.

17. The magnetorheological elastomer composite according to claim 1, wherein the magnetisable particles have an isotropic distribution in the elastomer matrix.

18. The magnetorheological elastomer composite according to at claim 1, which contains as additives dispersion agents, antioxidants, defoamers, surface modifiers, fillers, colourants and/or antiwear agents.

19. The magnetorheological elastomer composite according to claim 1, wherein relative to 100% by volume, the elastomer matrix contains 1 to 70% by volume of magnetisable particles.

20. The magnetorheological elastomer composite according to claim 19, which contains 0.1 to 20% by weight of additive, relative to the thermoplastic elastomer.

21. The magnetorheological elastomer composite according to claim 1, wherein the elongation at break of the elastomer composite is greater than 300%.

22. A method for producing the elastomer composite according to claim 1, wherein the thermoplastic elastomer is mixed with the plasticiser and the magnetisable particles and the composite is produced by heat treatment.

23. The method according to claim 22, wherein the thermoplastic elastomer is present in granulate form.

24. Use of the elastomer composite according to claim 1 for producing moulded articles by extrusion, injection moulding or casting.

25. Use according to claim 24, wherein a magnetic field is applied during and/or after extrusion, injection moulding or casting.

26. Use of the elastomer composite according to claim 24 wherein the composite is used in granulate form for producing moulded articles by extrusion, injection moulding or casting.

27. Use of the elastomer composite according to claim 1, as magnetically controllable elastomer composite together with a magnetic circuit which contains, apart from at least one electromagnet, also at least one permanent magnet for adjusting the operating point of the rigidity.

28. Use of the elastomer composite according to claim 1 as magnetically controllable elastomer composition for oscillation damping, oscillation isolation, actuators, safety switches, haptic systems or artificial muscles.

29. The magnetorheological elastomer composite according to claim 10, wherein the magnetically soft metallic materials are selected from the group consisting of iron, cobalt, nickel and alloys thereof.

30. The magnetorheological elastomer composite according to claim 11, wherein the magnetically soft oxide ceramic materials are selected from the group consisting of cubic ferrites, perovskites, and garnets of the general formula MO.Fe₂O₃ with one or more metals “M” selected from the group consisting of Mn, Fe, Co, Ni, Cu, Zn, Ti, Cd, Mg and mixtures thereof.

31. The magnetorheological elastomer composite according to claim 12, wherein the mixed ferrites are selected from the group consisting of MnZn⁻, NiZn⁻, NiCo⁻, NiCuCo⁻, NiMg⁻, CuMg⁻ ferrites and mixtures thereof.
